(19) United States
(12) Patent Application Publication
(10) Pub. No.: US 2018/0295645 A1
(43) Pub. Date: Oct. 11, 2018

(54) DEVICE TO DEVICE COMMUNICATIONS

(71) Applicant: NOKIA SOLUTIONS AND NETWORKS OY, Espoo (FI)

(72) Inventors: Ali Yaver, Rawalpindi (PK); Maciej Januszewski, Pila (PL); Fernando Sanchez Moya, Wroclaw (PL); Patrick Marsch, Wroclaw (PL); Matthias Hesse, Drebach (DE)

(21) Appl. No.: 15/778,613

(22) PCT Filed: Nov. 24, 2015
(86) PCT No.: PCT/EP2015/077453

§ 371 Date: May 23, 2018

(51) Int. Cl. H04W 72/14; H04W 76/14; H04L 5/00; H04W 72/04

(52) U.S. Cl. CPC H04W 72/14; H04W 72/042; H04L 5/0053; H04W 76/14

(57) ABSTRACT

The invention relates to an apparatus comprising: at least one processor and at least one memory including a computer program code, the at at least one memory and the computer program code configured to, with the at least one processor, cause the apparatus at least to: transmit an indication of device-to-device communications between a plurality of user devices to an access node; receive an information on a configuration for device-to-device control information signaling via the access node, and transmit the device-to-device control signalling according to the informed configuration via the access node.

### FIELD

The invention relates to communications.

### BACKGROUND

The following description of background art may include insights, discoveries, understandings or disclosures, or associations together with disclosures not known to the relevant art prior to the present invention but provided by the invention. Some such contributions of the invention may be specifically pointed out below, whereas other such contributions of the invention will be apparent from their context.

Device-to-Device (D2D) communications refers to a radio technology that enables devices to communicate directly with each other. Potential application scenarios comprise, for example, proximity-based services and public-safety support. Infrastructure-assisted device-to-device communication is one of the most prominent aspects of future D2D. In such a D2D system, resource allocation and other control operations are carried out, at least partially, by an access point providing cellular communications services. This is called as a device-infrastructure-device (DID) communications.

### SUMMARY

According to an aspect of the present invention, there is provided an apparatus comprising: at least one processor and at least one memory including a computer program code, the at least one memory and the computer program code configured to, with the at least one processor, cause the apparatus at least to: obtain an indication of device-to-device communication between a plurality of user devices; obtain information on an operation mode of the plurality of user devices; if the operation mode of the plurality of user devices is a half duplex mode: configure a cellular uplink control channel for a first user device of the plurality of user devices and a cellular downlink control channel for a second user device of the plurality of user devices for device-to-device control information as a pair of control channels; if the operation mode of the plurality of user devices is a full duplex mode: configure a cellular shared control channel and/or reallocate an existing cellular uplink control channel and/or an existing cellular downlink control channel for device-to-device control information; if the operation mode of at least one of the plurality of user devices is a half duplex mode and of at least one other of the plurality of user devices is a full duplex mode: configure for the at least one of the plurality of user devices in the half duplex mode a cellular uplink control channel and/or a cellular downlink control channel as a pair of control channels and configure a cellular shared control channel and/or reallocate an existing cellular uplink control channel and/or an existing cellular downlink control channel for the at least one other of the plurality of user devices in the full duplex mode, the cellular uplink control channel, the cellular downlink control channel and the cellular shared control channel being for device-to-device control information, and inform the configuration or the reallocation to at least one of the plurality of user devices.

According to an aspect of the present invention, there is provided an apparatus comprising: at least one processor and at least one memory including a computer program code, the at least one memory and the computer program code configured to, with the at least one processor, cause the apparatus at least to: transmit an indication of device-to-device communications between a plurality of user devices to an access node; receive an information on a configuration for device-to-device control information signaling via the access node, and transmit the device-to-device control signalling according to the informed configuration via the access node.

According to yet another aspect of the present invention, there is provided a method comprising: obtaining an indication of device-to-device communication between a plurality of user devices; obtaining information on an operation mode of the plurality of user devices; if the operation mode of the plurality of user devices is a half duplex mode: configuring a cellular uplink control channel for a first user device of the plurality of user devices and a cellular downlink control channel for a second user device of the plurality of user devices for device-to-device control information as a pair of control channels; if the operation mode of the plurality of user devices is a full duplex mode: configuring a cellular shared control channel and/or reallocating an existing cellular uplink control channel and/or an existing cellular downlink control channel for device-to-device control information; if the operation mode of at least one of the plurality of user devices is a half duplex mode and of at least one other of the plurality of user devices is a full duplex mode: configuring for the at least one of the plurality of user devices in the half duplex mode a cellular uplink control channel and/or a cellular downlink control channel as a pair of control channels and configuring a cellular shared control channel and/or reallocating an existing cellular uplink control channel and/or an existing cellular downlink control channel for the at least one other of the plurality of user devices in the full duplex mode, the cellular uplink control channel, the cellular downlink control channel and the cellular shared control channel being for device-to-device control information, and informing the configuration or the reallocation to at least one of the plurality of user devices.

According to yet another aspect of the present invention, there is provided an apparatus comprising means for obtaining an indication of device-to-device communication between a plurality of user devices, means for obtaining information on an operation mode of the plurality of user devices, means for, if the operation mode of the plurality of user devices is a half duplex mode, configuring a cellular uplink control channel for a first user device of the plurality of user devices and a cellular downlink control channel for a second user device of the plurality of user devices for device-to-device control information as a pair of control channels, means for, if the operation mode of the plurality of user devices is a full duplex mode, configuring a cellular shared control channel and/or reallocating an existing cellular uplink control channel and/or an existing cellular downlink control channel for device-to-device control information, means for, if the operation mode of at least one of the plurality of user devices is a half duplex mode and of at least one other of the plurality of user devices is a full duplex mode, configuring for the at least one of the plurality of user devices in the half duplex mode a cellular uplink control channel and/or a cellular downlink control channel as a pair of control channels and configuring a cellular shared control channel and/or reallocating an existing cellular uplink control channel and/or an existing cellular downlink control channel for the at least one other of the plurality of user devices in the full duplex mode, the cellular uplink control channel, the cellular downlink control channel and the cellular shared control channel being for device-to-device control information, and means for informing the configuration or the reallocation to at least one of the plurality of user devices.

According to yet another aspect of the present invention, there is provided an apparatus comprising means for transmitting an indication of device-to-device communications between a plurality of user devices to an access node, means for receiving an information on a configuration for device-to-device control information signaling via the access node, and means for transmitting the device-to-device control signalling according to the informed configuration via the access node.

According to yet another aspect of the present invention, there is provided a computer program embodied on a non-transitory computer-readable medium, the computer program comprising program code portions for controlling executing of a process, the process comprising: obtaining an indication of device-to-device communication between a plurality of user devices; obtaining information on an operation mode of the plurality of user devices; if the operation mode of the plurality of user devices is a half duplex mode: configuring a cellular uplink control channel for a first user device of the plurality of user devices and a cellular downlink control channel for a second user device of the plurality of user devices for device-to-device control information as a pair of control channels; if the operation mode of the plurality of user devices is a full duplex mode: configuring a cellular shared control channel and/or reallocating an existing cellular uplink control channel and/or an existing cellular downlink control channel for device-to-device control information; if the operation mode of at least one of the plurality of user devices is a half duplex mode and of at least one other of the plurality of user devices is a full duplex mode: configuring for the at least one of the plurality of user devices in the half duplex mode a cellular uplink control channel and/or a cellular downlink control channel as a pair of control channels and configuring a cellular shared control channel and/or reallocating an existing cellular uplink control channel and/or an existing cellular downlink control channel for the at least one other of the plurality of user devices in the full duplex mode, the cellular uplink control channel, the cellular downlink control channel and the cellular shared control channel being for device-to-device control information, and informing the configuration or the reallocation to at least one of the plurality of user devices.

According to yet another aspect of the present invention, there is provided: computer program embodied on a non-transitory computer-readable medium, the computer program comprising program code portions for controlling executing of a process, the process comprising: transmitting an indication of device-to-device communications between a plurality of user devices to an access node; receiving an information on a configuration for device-to-device control information signaling via the access node, and transmitting the device-to-device control signalling according to the informed configuration via the access node.

### LIST OF DRAWINGS

Some embodiments of the present invention are described below, by way of example only, with reference to the accompanying drawings, in which

FIG. 1 illustrates an example of a system;

FIG. 2 is a flow chart;

FIG. 3 is another flow chart;

FIG. 4 depicts an example of signaling;

FIG. 5 depicts another example of signaling;

FIG. 6 illustrates an example of a PSCCH configuration;

FIG. 7 shows an example of an apparatus, and

FIG. 8 shows another example of an apparatus.

### DESCRIPTION OF SOME EMBODIMENTS

Some embodiments of the present invention will now be described hereinafter with reference to accompanying drawings. It should be appreciated that the invention may be embodied in many different forms and should not be construed as limited to the embodiments set forth herein.

The following embodiments are only examples. Although the specification may refer to “an”, “one”, or “some” embodiment(s) in several locations, this does not necessarily mean that each such reference is to the same embodiment(s), or that the feature only applies to a single embodiment. Single features of different embodiments may also be combined to provide other embodiments. Furthermore, words “comprising” and “including” should be understood as not limiting the described embodiments to consist of only those features that have been mentioned and such embodiments may also contain also features, structures, units, modules etc. that have not been specifically mentioned.

Embodiments are applicable to any user device, such as a user terminal, as well as to any network element, relay node, server, node, corresponding component, and/or to any communication system or any combination of different communication systems that support required functionalities. The communication system may be a wireless communication system or a communication system utilizing both fixed networks and wireless networks. The protocols used, the specifications of communication systems, apparatuses, such as servers and user terminals, especially in wireless communication, develop rapidly. Such development may require extra changes to an embodiment. Therefore, all words and expressions should be interpreted broadly and they are intended to illustrate, not to restrict, embodiments.

In the following, different exemplifying embodiments will be described using, as an example of an access architecture to which the embodiments may be applied, a radio access architecture based on long term evolution advanced (LTE Advanced, LTE-A), without restricting the embodiments to such an architecture, however. It is obvious for a person skilled in the art that the embodiments may also be applied to other kinds of communications networks having suitable means by adjusting parameters and procedures appropriately. Some examples of other options for suitable systems are 5G, the universal mobile telecommunications system (UMTS) radio access network (UTRAN or E-UTRAN), long term evolution (LTE, the same as E-UTRA), wireless local area network (WLAN or WiFi), worldwide interoperability for microwave access (WiMAX), Bluetooth®, personal communications services (PCS), ZigBee®, wideband code division multiple access (WCDMA), systems using ultra-wideband (UWB) technology, sensor networks, mobile ad-hoc networks (MANETs) and Internet Protocol multimedia subsystems (IMS) or any combination thereof.

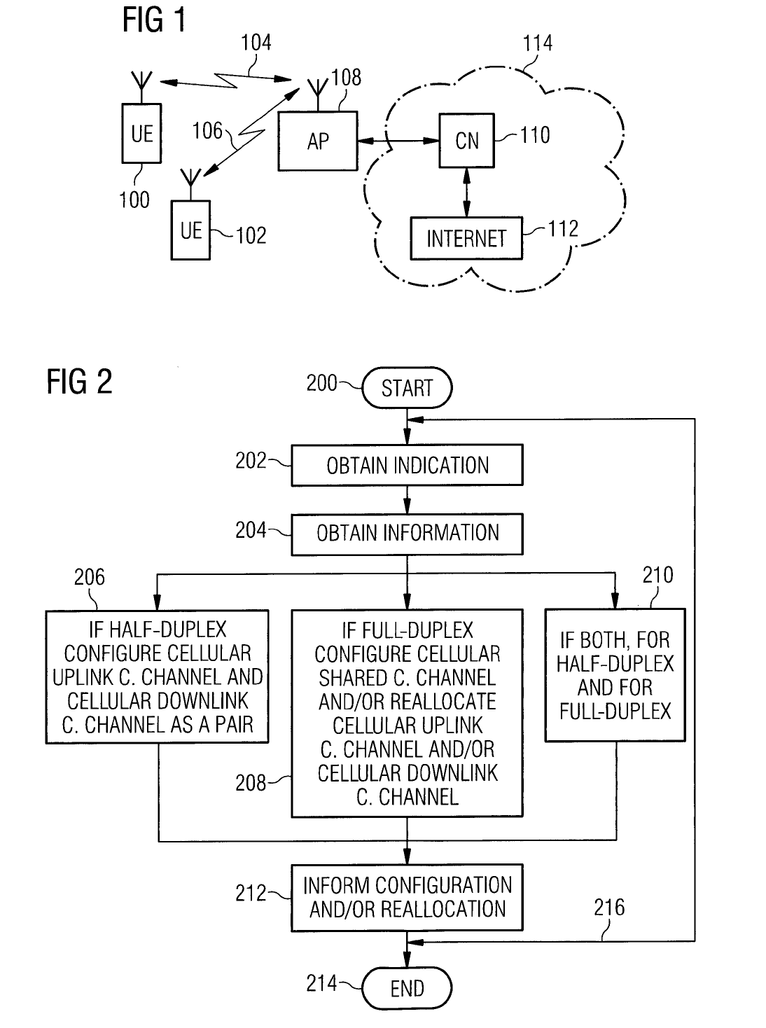

FIG. 1 depicts examples of simplified system architectures only showing some elements and functional entities, all being logical units, whose implementation may differ from what is shown. The connections shown in FIG. 1 are logical connections; the actual physical connections may be different. It is apparent to a person skilled in the art that the system typically comprises also other functions and structures than those shown in FIG. 1.

The embodiments are not, however, restricted to the system given as an example but a person skilled in the art may apply the solution to other communication systems provided with necessary properties. Another example of a suitable communications system is the 5G concept. 5G is likely to use multiple input-multiple output (MIMO) antennas, many more base stations or nodes than the LTE (a so-called small cell concept), including macro sites operating in co-operation with smaller stations and perhaps also employing a variety of radio technologies for better coverage and enhanced data rates. 5G will likely be comprised of more than one radio access technology (RAT), each optimized for certain use cases and/or spectrum. 5G mobile communications will have a wider range of use cases and related applications including video streaming, augmented reality, different ways of data sharing and various forms of machine type applications, including vehicular safety, different sensors and real-time control. 5G is expected to have multiple radio interfaces, namely below 6 GHz, cmWave and mmWave, and also being integradable with existing legacy radio access technologies, such as the LTE. Integration with the LTE may be implemented, at least in the early phase, as a system, where macro coverage is provided by the LTE and 5G radio interface access comes from small cells by aggregation to the LTE. In other words, 5G is planned to support both inter-RAT operability (such as LTE-5G) and inter-RI operability (inter-radio interface operability, such as below 6 GHz-cmWave, below 6 GHz-cmWave-mmWave). One of the concepts considered to be used in 5G networks is network slicing in which multiple independent and dedicated virtual sub-networks (network instances) may be created within the same infrastructure to run services that have different requirements on latency, reliability, throughput and mobility.

It should be appreciated that future networks will most probably utilise network functions virtualization (NFV) which is a network architecture concept that proposes virtualizing network node functions into “building blocks” or entities that may be operationally connected or linked together to provide services. A virtualized network function (VNF) may comprise one or more virtual machines running computer program codes using standard or general type servers instead of customized hardware. Cloud computing or data storage may also be utilized. In radio communications this may mean node operations to be carried out, at least partly, in a server, host or node operationally coupled to a remote radio head. It is also possible that node operations will be distributed among a plurality of servers, nodes or hosts. It should also be understood that the distribution of labour between core network operations and base station operations may differ from that of the LTE or even be non-existent. Some other technology advancements probably to be used are Software-Defined Networking (SDN), Big Data, and all-IP, which may change the way networks are being constructed and managed.

Various techniques described herein may also be applied to a cyber-physical system (CPS) (a system of collaborating computational elements controlling physical entities). CPS may enable the implementation and exploitation of massive amounts of interconnected ICT devices (sensors, actuators, processors microcontrollers, etc.) embedded in physical objects at different locations. Mobile cyber physical systems, in which the physical system in question has inherent mobility, are a subcategory of cyber-physical systems. Examples of mobile physical systems include mobile robotics and electronics transported by humans or animals.

FIG. 1 shows a part of a radio access network based on E-UTRA, LTE, LTE-Advanced (LTE-A) or LTE/EPC (EPC=evolved packet core, EPC is enhancement of packet switched technology to cope with faster data rates and growth of Internet protocol traffic). E-UTRA is an air interface of LTE Release 8 (UTRA=UMTS terrestrial radio access, UMTS=universal mobile telecommunications system). Some advantages obtainable by LTE (or E-UTRA) are a possibility to use plug and play devices, and Frequency Division Duplex (FDD) and Time Division Duplex (TDD) in the same platform.

FIG. 1 shows user devices 100 and 102 configured to be in a wireless connection on one or more communication channels 104 and 106 in a cell with a (e)NodeB 108 providing the cell. The (e)NodeB is an example of an access node. The physical link from a user device to a (e)NodeB is called uplink or reverse link and the physical link from the (e)NodeB to the user device is called downlink or forward link.

The NodeB, or advanced evolved node B (eNodeB, eNB) in LTE-Advanced, is a computing device configured to control the radio resources of communication system it is coupled to. The (e)NodeB may also be referred to as a base station, an access point or any other type of interfacing device including a relay station capable of operating in a wireless environment.

The (e)NodeB includes or is coupled to transceivers. From the transceivers of the (e)NodeB, a connection is provided to an antenna unit that establishes bi-directional radio links to user devices. The antenna unit may comprise a plurality of antennas or antenna elements. The (e)NodeB is further connected to core network 110 (CN). Depending on the system, the counterpart on the CN side can be a serving gateway (S-GW, routing and forwarding user data packets), packet data network gateway (P-GW), for providing connectivity of user devices (UEs) to external packet data networks, or mobile management entity (MME), etc. The core network operations may also be carried out at least partially by using cloud services which is depicted by dotted arrow cloud 114.

It should be appreciated that a communications system typically comprises more than one (e)NodeB in which case the (e)NodeBs may also be configured to communicate with one another over links, wired or wireless, designed for the purpose. These links may be used for signalling purposes.

The communication system is also able to communicate with other networks, such as a public switched telephone network or the Internet 112. The communication network may also be able to support the usage of cloud services. It should be appreciated that (e)NodeBs or their functionalities may be implemented by using any node, host, server or access point etc. entity suitable for such a usage.

The communication system may also comprise a central control entity, or a like, providing facilities for networks of different operators to cooperate for example in spectrum sharing.

The user device (also called UE, user equipment, user terminal, terminal device, etc.) illustrates one type of an apparatus to which resources on the air interface are allocated and assigned, and thus any feature described herein with a user device may be implemented with a corresponding apparatus, such as a relay node. An example of such a relay node is a layer 3 relay (self-backhauling relay) towards the base station.

The user device typically refers to a portable computing device that includes wireless mobile communication devices operating with or without a subscriber identification module (SIM), including, but not limited to, the following types of devices: a mobile station (mobile phone), smartphone, personal digital assistant (PDA), handset, device using a wireless modem (alarm or measurement device, etc.), laptop and/or touch screen computer, tablet, game console, notebook, and multimedia device. It should be appreciated that a user device may also be a nearly exclusive uplink only device, of which an example is a camera or video camera loading images or video clips to a network. A user device may also be a device having capability to operate in Internet of Things (IoT) network which is a scenario in which objects are provided with the ability to transfer data over a network without requiring human-to-human or human-to-computer interaction.

The user device (or in some embodiments a layer 3 relay node) is configured to perform one or more of user equipment functionalities. The user device may also be called a subscriber unit, mobile station, remote terminal, access terminal, user terminal or user equipment (UE) just to mention but a few names or apparatuses.

It should be understood that, in FIG. 1, user devices are depicted to include 2 antennas only for the sake of clarity. The number of reception and/or transmission antennas may naturally vary according to a current implementation.

Additionally, although the apparatuses have been depicted as single entities, different units, processors and/or memory units (not all shown in FIG. 1) may be implemented.

It is obvious for a person skilled in the art that the depicted system is only an example of a part of a radio access system and in practise, the system may comprise a plurality of (e)NodeBs, the user device may have an access to a plurality of radio cells and the system may comprise also other apparatuses, such as physical layer relay nodes or other network elements, etc. At least one of the NodeBs or eNodeBs may be a Home(e)nodeB. Additionally, in a geographical area of a radio communication system a plurality of different kinds of radio cells as well as a plurality of radio cells may be provided. Radio cells may be macro cells (or umbrella cells) which are large cells, usually having a diameter of up to tens of kilometres, or smaller cells such as micro-, femto- or picocells. The (e) NodeBs of FIG. 1 may provide any kind of these cells. A cellular radio system may be implemented as a multilayer network including several kinds of cells. Typically, in multilayer networks, one node B provides one kind of a cell or cells, and thus a plurality of (e) Node Bs are required to provide such a network structure.

For fulfilling the need for improving the deployment and performance of communication systems, the concept of “plug-and-play” (e)NodeBs has been introduced. Typically, a network which is able to use “plug-and-play” (e)Node Bs, includes, in addition to Home (e)NodeBs (H(e)nodeBs), a home node B gateway, or HNB-GW (not shown in FIG. 1). A HNB Gateway (HNB-GW), which is typically installed within an operator's network may aggregate traffic from a large number of HNBs back to a core network.

Device-to-Device (D2D) communication refers to a radio technology that enables devices to communicate directly with each other. Potential application scenarios comprise, for example, proximity-based services, wherein devices detect their proximity and subsequently trigger different services, such as social applications, receiving advertisements, local exchange of information and communications between vehicles: in machine type communications (MTC), D2D may provide a low-latency and reliable way to communicate among vehicles or other machines with or without the assistance of the network. Other applications include public safety support, wherein devices provide at least local connectivity even in case of damage to the radio infrastructure.

Infrastructure-assisted device-to-device communication is one of the most prominent aspects of future D2D. In such a D2D system, resource allocation and other control operations are carried out, at least partially, by an access point (access node, called in the LTE-A eNodeB) providing cellular communications services; the access point grants resources in for D2D links in a cellular system. Data transfer between devices may take place directly between user devices or it may be relayed through the access point(s) (AP) depending, for example, on the proximity of devices. These two modes of data exchange are referred as D2D and DID (device-infrastructure-device), respectively.

In the following, embodiments suitable for device-to-device communications (D2D), especially for device dependent control channel signaling for D2D are disclosed in further detail.

D2D and/or DID need multiple control signaling anchors. On one hand, devices need to exchange control information among them and on the other hand, a radio access network entity or an access point (AP) has to be able to monitor and control communications resources when required.

It should be appreciated that control signaling typically extends to different timescales in a similar fashion than in a cellular network. For example, scheduling decisions may take place at a transmission time interval (III) scale. Some other physical layer or medium access control (MAC) layer operations, such as link adaptation, channel state information (CSI) reporting, hybrid automatic repeat request (HARQ) feedback, buffer status reporting and power control, may require a fast time scale operation. Whereas some other operations, such as authorization, mode-selection (switching between D2D and DID), mobility related operations etc. may take place at a slower time scale.

D2D users may be authorized to share time and frequency resources with cellular and/or other D2D users. This requires resource coordination and interference management. Since an access point or node (network entity) is in the charge of resource allocation, it is important for the network to be aware of signaling being carried out.

Additionally, it is supposed that in 5G D2D traffic can be scheduled in both uplink and downlink data frames whereas in the LTE ProSe, direct communication or direct discovery takes place in uplink only.

One embodiment starts in block 200 of FIG. 2. This embodiment discloses a procedure which may be carried out by an access point. The embodiment provides control signalling for D2D in a device-specific manner.

In block 202, an indication of device-to-device communications between a plurality of user devices is obtained. In block 204, information on an operation mode of the plurality of user devices is obtained.

User device may be in a half-duplex mode or in a full-duplex mode. In a half-duplex system, each party can communicate with the other party but not simultaneously; the communication is one direction at a time. In a full duplex system, both parties can communicate with each other simultaneously. This usually applies to a frequency division duplex system.

The information on the operation mode may be comprised in the indication or it may be received separately, for example as a response to a request.

An indication of the D2D communications may be a request for control signaling resources. The indication may be received from the user device having a need to transmit control information (a source user device) to one or more target user devices.

It should be appreciated that the number of D2D devices may vary case by case.

In blocks 206, if the operation mode of the plurality of user devices is a half duplex mode: a cellular uplink control channel for a first user device of the plurality of user devices and a cellular downlink control channel for a second user device of the plurality of user devices is configured for D2D control information as a pair of control channels.

An example of a cellular uplink control channel is a physical uplink control channel (PUCCH) and an example of a cellular downlink control channel is a physical downlink control channel (PDCCH). These cellular control channels may be in a control information format for D2D control signalling (D2DCI format). The format may be similar to the one used for normal cellular communications. It should be understood that the control information may be conveyed as a point-to-point transmission, multicast or broadcast. Channel selection/assignment may be realised in a similar fashion as for cellular communications.

The uplink control channel and the downlink control channel may be marked or identified as paired either by a pairing identity (ID) or by identifying a source (first) user device and a destination (second) user device, for example. The uplink control channel and the downlink control channel are configured and controlled as a pair of channels. The information from the source user device is received and transmitted/multicast/broadcast or relayed/forwarded towards the target user device using the downlink control channel paired with the uplink control channel used for the data transmission by the source user device.

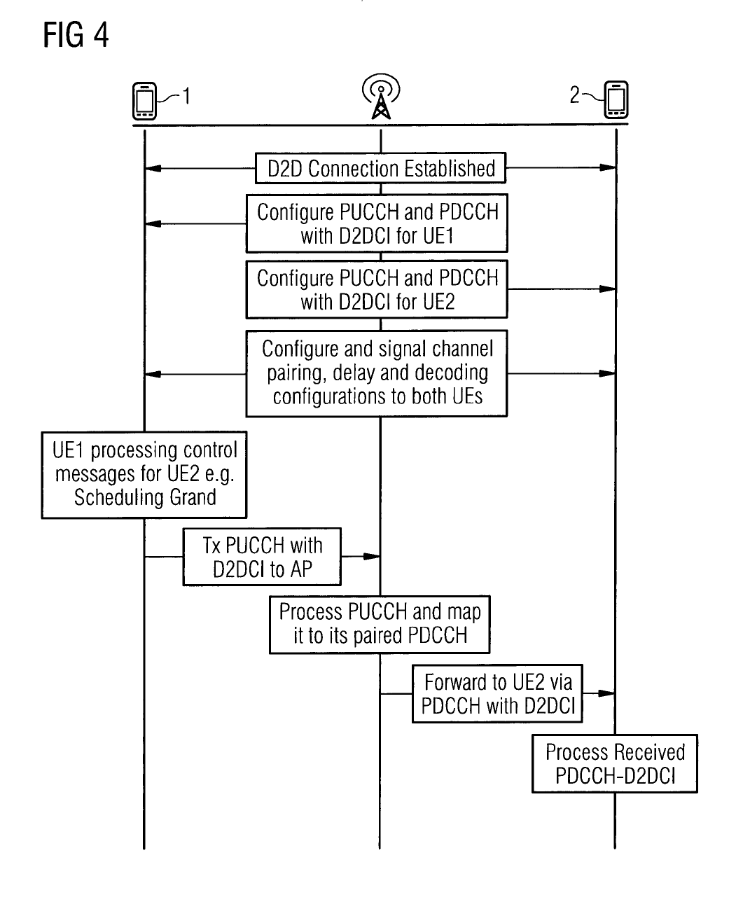

In FIG. 4, an example of a signalling chart of an embodiment, wherein a pair of a cellular uplink control channel and a cellular downlink control channel is configured for D2D control signalling. In this example, the first user device (source) is referred as 1 and the second user device (target) is referred as 2 and the control signalling is conveyed via an access point. The D2D connection establishment includes obtaining an indication of device-to-device communications between a plurality of user devices.

The number of user devices may vary and there may also be a group or cluster of user devices involved in D2D communications.

In block 208, if the operation mode of the plurality of user devices is a full duplex mode: a cellular shared control channel is configured or an existing cellular uplink control channel and/or an existing cellular downlink control channel (for example, configured earlier for normal cellular communications) are reallocated for device-to-device control information.

Frequency division duplex (FDD) full duplex user devices are a class of user devices which may have multiple radio frequency chains and are able to support simultaneous transmission and reception in different frequency bands. An FDD full-duplex user device is able to receive and transmit information in the same symbol provided that enough separation between the transmission band and the reception band is provided.

A shared control channel is one channel shared between an uplink and downlink transmission. It may be physical shared control channel (PSCCH).

Upon D2D connection request or request for D2D control signalling, a user device may inform its category or capability to indicate whether it supports full duplex FDD. Another option is that the access point requests the information from the source user device or both the source user device and the target user device. The user device may also indicate a guard band required between simultaneous transmission and reception. A guard band or a set of guard band values may also be negotiated, for example based on interference measurements, or standardized.

In one embodiment, after configuring a shared channel, an uplink channel or a downlink channel, such as a PUCCH or PDCCH, may further be configured separated by a guard band in a non-contiguous subcarrier.

In another embodiment, if an uplink and/or downlink control channel has been allocated to a user device for normal cellular communications, the shared control channel may be separated by a guard band in a non-contiguous subcarrier.

In another embodiment, if an uplink and/or downlink control channel has been allocated to a user device for normal cellular communications and it is not possible to allocate a shared channel for D2D communications control, a reallocation of an uplink control channel and/or downlink control channel is carried out for achieving required separation of transmission. The separation may be based on the usage of a guard band.

In another embodiment, if no non-contiguous frequency bands are available, a cellular uplink control channel or a cellular downlink control channel may be reallocated to a cellular user device.

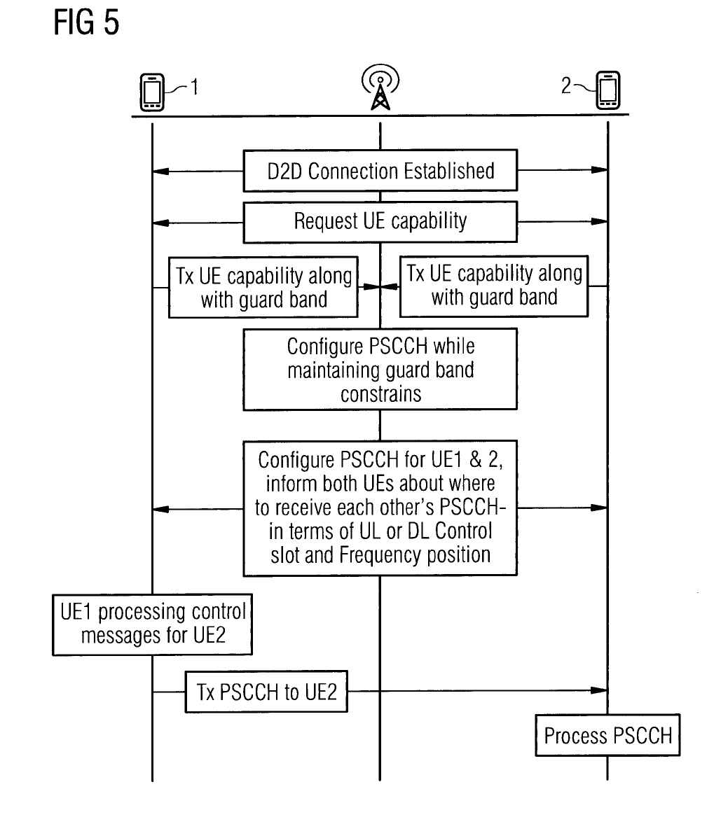

In FIG. 5, an example of a cellular shared control channel for D2D control information signalling is shown by a signalling chart. In this example, the first user device (source) is referred as 1 and the second user device (target) is referred as 2 and the control signalling is conveyed via an access point. The D2D connection establishment includes obtaining an indication of device-to-device communications between a plurality of user devices. The source user device may request for user device (UE) capability from the target user device and the access point is informed by the source user device, or the access node may request the capability information. In this example both user devices inform the access node about their capabilities and the required guard bands. The access point informs time slot and frequency band configurations to the user devices.

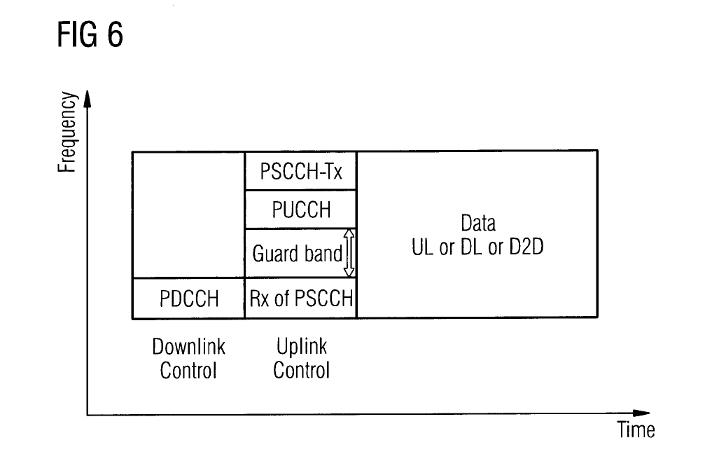

In FIG. 6, an example of a PSCCH configuration for uplink control signalling is shown. In the case of setting up a PSCCH for downlink control signalling, the PSCCH-transmission part is moved to the downlink (DL) control part along with a guard band in such a manner that a FDD full duplex user device is able to receive downlink control information while transmitting on the PSCCH.

In block 210, if the operation mode of at least one of the plurality of user devices is a half duplex mode and of at least one other of the plurality of user devices is a full duplex mode: at least one of the following for the at least one of the plurality of user devices in the half duplex mode is configured: a cellular uplink control channel and a cellular downlink control channel as a pair of control channels, and for the at least one other of the plurality of user devices in the full duplex mode a cellular shared control channel is configured or an existing cellular uplink control channel and/or an existing cellular downlink control channel are reallocated, the cellular uplink control channel, the cellular downlink control channel and the cellular shared control channel being for D2D control information.

Further details and/or some embodiments are presented above.

In block 212, the configuration and/or reallocation is informed to at least one of the plurality of user devices by transmitting, multicasting or broadcasting. In the case an identification indicator exists, it may also be informed to the plurality of user devices.

The configuration of the cellular uplink control channel may be informed to the first user device and the configuration of the cellular downlink control channel may be informed to the second user device as a point-to-point transmission.

In one embodiment, controlling of D2D control signalling may be carried out as follows:
1) Processing information before forwarding it to a source user device, this is a PROCESS AND FORWARD mode. For example, information received over PUCCH is processed before being forwarded to the destination over PDCCH. This provides an option to control the information flow.
2) Forwarding the information and processing it later, a FORWARD AND PROCESS mode. The purpose is to use the first opportunity to forward the message and yet providing the monitoring option.
3) Only forwarding the information, a FORWARD ONLY mode.
4) Retaining some of the information while forwarding the rest, a RETAIN AND FORWARD mode. For example, some of control information is retained at the AP. An example of this aspect is buffer status report (BSR). While the source user device (the transmitter) may be configured to send the D2D specific BSR via PUCCH, the BSR information itself may be relevant for the entity in charge of the scheduling decisions, e.g. the AP, and it is not necessarily relevant for the target user device. Therefore AP may not forward the BSR field of the control channel while forwarding the rest. Another example of this aspect is HARQ feedback where only the AP may be interested in feedback since the AP could possibly be configured to schedule retransmissions.
5) Appending an uplink control channel with additional information before relaying or forwarding an APPEND AND FORWARD mode.

This option may be used alone or with other options, such as PROCESS AND FORWARD and RETAIN AND FORWARD. For example, some additional information may be added to the received PUCCH before sending it over PDCCH. Example of this may be scheduling grants for retransmissions. In this example the HARQ feedback is retained at the access point (AP) while the retransmissions are scheduled for the D2D transmitter. The said grant for the target user device may be appended to PDCCH. Another example would be open loop power control. For efficient D2D Power Control, an open loop power control between devices and AP and a closed loop power control at a fast scale between devices themselves may be applied. Such open loop power control commands may be appended to PDCCH.

Each of these options gives an AP a possibility to have full control, partial control or no control over D2D communication. In partial control, the AP may choose to monitor only some parameters, one example is HARQ: if a data frame is not received correctly, the AP will be the first to receive a NACK. Instead of forwarding the NACK to the source user device, the AP may simply schedule a retransmission. In full control, the AP may decode and process everything sent over the configured D2D control channels. Full or partial control may also be applied to scheduling. In partially controlled resource allocation, the AP reserves a pool of resources and user devices select among themselves which resources to use.

In one embodiment, a timer which indicates the amount of time between the transmission of an uplink control channel and its paired downlink control channel is transmitted to user devices. The timer may be sent as part of initial configuration message or via a dedicated radio resource control (RRC) message or as part of broadcast signalling. For example, if the value of the timer is zero, the access point is going to forward received uplink control information in the immediate TTI following the reception. If the timer is set to 1, the access point is going to introduce an additional delay of 1 TTI before forwarding the received uplink control information. The timer may be adapted to a processing delay in the access node.

While the data transmission itself may be carried out directly between devices in D2D mode or indirectly in DID mode using 2 hops (via an access point), the control information is conveyed in two hops (via the access point). In one embodiment, the device-to-device control information received on the cellular uplink control channel is conveyed (e.g. forwarded) by using the cellular downlink control channel and/or the device-to-device control information received on the cellular shared control channel is conveyed by using the cellular shared control channel.

The embodiment ends in block 214. The embodiment is repeatable in many ways. An example is shown by arrow 216 in FIG. 2. It should be understood that the embodiment may be repeated one or more times with a constant or variable pause between separate rounds.

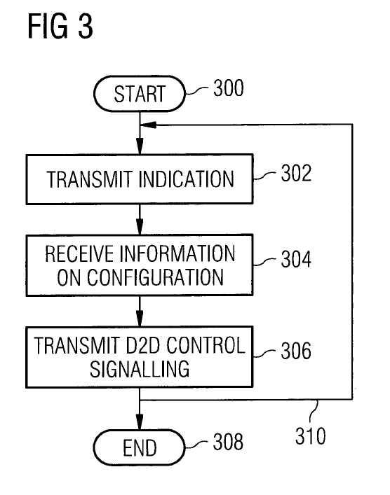

Another embodiment starts in block 300 of FIG. 3. This embodiment presents a procedure suitable for being carried out by a user device transmitting and/or receiving D2D control information.

In block 302, an indication of device-to-device communications between a plurality of user devices is transmitted to an access node. The indication may comprise information on an operation mode of at least one of the plurality of user devices. User device may be in a half-duplex mode or in a full-duplex mode. In a half-duplex system, each party can communicate with the other but not simultaneously; the communication is one direction at a time. In a full duplex system, both parties can communicate with each other simultaneously. This usually applies to a frequency division duplex system.

An indication of the D2D communications may be a request for control signaling resources. The indication may be received from the user device having a need to transmit control information (a source user device) to one or more target user devices.

A user device may inform its category or capability to indicate whether it supports full duplex FDD. The user device may also indicate a guard band required between simultaneous transmission and reception. A guard band or a set of guard band values may also be negotiated, for example based on interference measurements, or standardized.

It should be appreciated that the number of D2D devices may vary case by case.

In block 304, information on configuration for D2D control information signaling via the access node is received.

There are a plurality of options for the configuration: if the operation mode of the plurality of user devices is a half duplex mode: a cellular uplink control channel for a source user device and a cellular downlink control channel for a target user device is configured for D2D control information as a pair of control channels.

An example of a cellular uplink control channel is a physical uplink control channel (PUCCH) and an example of a cellular downlink control channel is a physical downlink control channel (PDCCH). These cellular control channels may be in a control information format for D2D control signalling (D2DCI format). The format may be similar to the one used for normal cellular communications. It should be understood that the control information may be conveyed as a point-to-point transmission, multicast or broadcast. Channel selection/assignment may be realised in a similar fashion as for cellular communications.

The uplink control channel and the downlink control channel may be paired either by a pairing identity (ID) or by identifying a source (first) user device and a destination (second) user device, for example. The uplink control channel and the downlink control channel are configured and controlled as a pair of channels. The information from the source user device is received and transmitted/multicast/broadcast or relayed/forwarded towards the target user device using the downlink control channel paired with the uplink control channel used for the data transmission by the source user device. In other words, information on the configuration may also comprise this paring identity.

Another option: if the operation mode of the plurality of user devices is a full duplex mode: a cellular shared control channel for D2D control information is configured or an existing cellular uplink control channel and/or an existing cellular downlink control channel are reallocated.

Yet another option: if the operation mode of at least one of the plurality of user devices is a half duplex mode and of at least one other of the plurality of user devices is a full duplex mode: at least one of the following for the at least one of the plurality of user devices in the half duplex mode is configured: a cellular uplink control channel and a cellular downlink control channel as a pair of control channels, and an identification indicator to the pair of control channels is assigned; and a cellular shared control channel is configured or an existing cellular uplink control channel and/or an existing cellular downlink control channel are reallocated for the at least one other of the plurality of user devices in the full duplex mode, the cellular uplink control channel, the cellular downlink control channel and the cellular shared control channel being for D2D control information.

In block 306, the D2D control signaling is transmitted according to the informed configuration via the access node.

While the data transmission itself may be carried out directly between devices in D2D mode or indirectly in DID mode using 2 hops (via an access point), the control information is conveyed in two hops (via the access point).

Some further examples are presented above in relation to FIGS. 4, 5 and 6.

The embodiment ends in block 308. The embodiment is repeatable in many ways. An example is shown by arrow 310 in FIG. 3. It should be understood that the embodiment may be repeated one or more times with a constant or variable pause between separate rounds.

The steps/points, signaling messages and related functions described above in FIGS. 2, 3, 4 and 5 are in no absolute chronological order, and some of the steps/points may be performed simultaneously or in an order differing from the given one. Other functions may also be executed between the steps/points or within the steps/points and other signaling messages sent between the illustrated messages. Some of the steps/points or part of the steps/points can also be left out or replaced by a corresponding step/point or part of the step/point.

It should be understood that conveying, broadcasting, signalling transmitting and/or receiving may herein mean preparing a data conveyance, broadcast, transmission and/or reception, preparing a message to be conveyed, broadcasted, signalled, transmitted and/or received, or physical transmission and/or reception itself, etc. on a case by case basis. The same principle may be applied to terms transmission and reception as well.

An embodiment provides an apparatus which may be a node, host or server or any other suitable apparatus capable to carry out processes described above in relation to FIGS. 2, 4 and/or 5.

It should be appreciated that the apparatus may include or otherwise be in communication with a control unit, one or more processors or other entities capable of carrying out operations according to the embodiments described by means of FIGS. 2, 4 and/or 5. It should be understood that each block of the flowchart of FIG. 2 and any combination thereof may be implemented by various means or their combinations, such as hardware, software, firmware, one or more processors and/or circuitry.

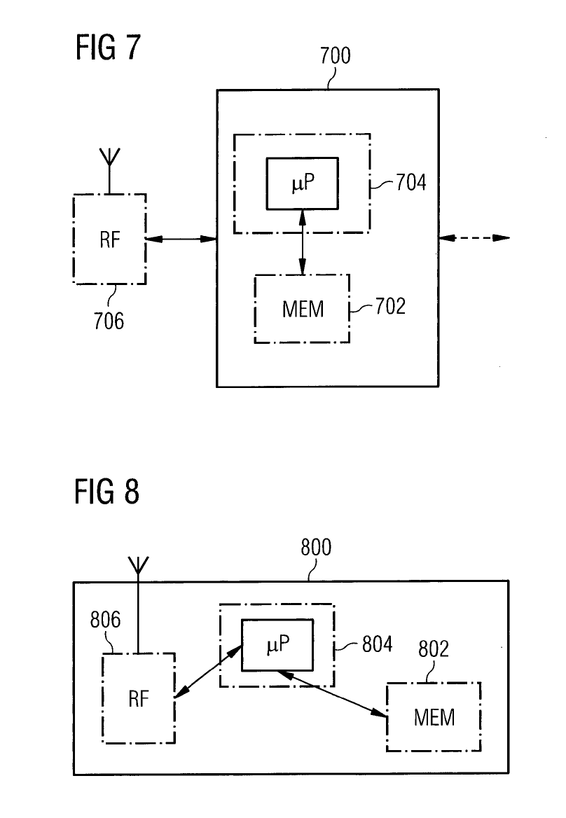

FIG. 7 illustrates a simplified block diagram of an apparatus according to an embodiment in relation to FIGS. 2 (4, 5 and 6).

As an example of an apparatus according to an embodiment, it is shown apparatus 700, such as a node (eNodeB, for example), including facilities in control unit or control circuitry 704 (including one or more processors, for example) to carry out functions of embodiments according to FIG. 2. The facilities may be software, hardware or combinations thereof as described in further detail below.

In FIG. 7, block 706 includes parts/units/modules needed for reception and transmission, usually called a radio front end, RF-parts, radio parts, remote radio head, radio entity, etc. The parts/units/modules needed for reception and transmission may be comprised in the apparatus or they may be located outside the apparatus the apparatus being operationally coupled to them. The apparatus may also include or be coupled to one or more internal or external memory units.

Another example of apparatus 700 may include at least one processor 704 and at least one memory 702 including a computer program code, the at least one memory and the computer program code configured to, with the at least one processor, cause the apparatus at least to: obtain an indication of device-to-device communication between a plurality of user devices, obtain information on an operation mode of the plurality of user devices, if the operation mode of the plurality of user devices is a half duplex mode: configure a cellular uplink control channel for a first user device of the plurality of user devices and a cellular downlink control channel for a second user device of the plurality of user devices for device-to-device control information as a pair of control channels, if the operation mode of the plurality of user devices is a full duplex mode: configure a cellular shared control channel and/or reallocate an existing cellular uplink control channel and/or an existing cellular downlink control channel for device-to-device control information, if the operation mode of at least one of the plurality of user devices is a half duplex mode and of at least one other of the plurality of user devices is a full duplex mode: configure for the at least one of the plurality of user devices in the half duplex mode a cellular uplink control channel and/or a cellular downlink control channel as a pair of control channels and configure a cellular shared control channel and/or reallocate an existing cellular uplink control channel and/or an existing cellular downlink control channel for the at least one other of the plurality of user devices in the full duplex mode, the cellular uplink control channel, the cellular downlink control channel and the cellular shared control channel being for device-to-device control information, and inform the configuration or the reallocation to at least one of the plurality of user devices.

It should be understood that the apparatus may include or be coupled to other units or modules etc., such as radio parts or radio heads, used in or for transmission and/or reception. This is depicted in FIG. 7 as optional block 706.

Yet another example of an apparatus comprises means 704 (706) for obtaining an indication of device-to-device communication between a plurality of user devices, means 704 (706) for obtaining information on an operation mode of the plurality of user devices, means 704 for, if the operation mode of the plurality of user devices is a half duplex mode, configuring a cellular uplink control channel for a first user device of the plurality of user devices and a cellular downlink control channel for a second user device of the plurality of user devices for device-to-device control information as a pair of control channels, means 704 for, if the operation mode of the plurality of user devices is a full duplex mode, configuring a cellular shared control channel and/or reallocating an existing cellular uplink control channel and/or an existing cellular downlink control channel for device-to-device control information, means 704 for, if the operation mode of at least one of the plurality of user devices is a half duplex mode and of at least one other of the plurality of user devices is a full duplex mode, configuring for the at least one of the plurality of user devices in the half duplex mode a cellular uplink control channel and/or a cellular downlink control channel as a pair of control channels and configuring a cellular shared control channel and/or reallocating an existing cellular uplink control channel and/or an existing cellular downlink control channel for the at least one other of the plurality of user devices in the full duplex mode, the cellular uplink control channel, the cellular downlink control channel and the cellular shared control channel being for device-to-device control information, and means 704, 706 for informing the configuration or the reallocation to at least one of the plurality of user devices.

It should be understood that the apparatus may include or be coupled to other units or modules etc., such as radio parts or radio heads, used in or for transmission and/or reception. This is depicted in FIG. 7 as optional block 706.

Although the apparatuses have been depicted as one entity in FIG. 7, different modules and memory may be implemented in one or more physical or logical entities.

Another embodiment provides an apparatus which may be a user device or any other suitable apparatus capable to carry out processes described above in relation to FIGS. 3, 4 and/or 5.

It should be appreciated that the apparatus may include or otherwise be in communication with a control unit, one or more processors or other entities capable of carrying out operations according to the embodiments described by means of FIGS. 3, 4 and/or 5. It should be understood that each block of the flowchart of FIG. 3 and any combination thereof may be implemented by various means or their combinations, such as hardware, software, firmware, one or more processors and/or circuitry.

FIG. 8 illustrates a simplified block diagram of an apparatus according to an embodiment in relation to FIGS. 3 (4, 5 and 6).

As an example of an apparatus according to an embodiment, it is shown apparatus 800, such as a user device, including facilities in control unit or control circuitry 804 (including one or more processors, for example) to carry out functions of embodiments according to FIG. 3. The facilities may be software, hardware or combinations thereof as described in further detail below.

In FIG. 8, block 806 includes parts/units/modules needed for reception and transmission, usually called a radio front end, RF-parts, radio parts, remote radio head, radio entity, etc. The parts/units/modules needed for reception and transmission may be comprised in the apparatus or they may be located outside the apparatus the apparatus being operationally coupled to them. The apparatus may also include or be coupled to one or more internal or external memory units.

Another example of apparatus 800 may include at least one processor 804 and at least one memory 802 including a computer program code, the at least one memory and the computer program code configured to, with the at least one processor, cause the apparatus at least to: transmit an indication of device-to-device communications between a plurality of user devices to an access node; receive an information on a configuration for device-to-device control information signaling via the access node, and transmit the device-to-device control signalling according to the informed configuration via the access node.

It should be understood that the apparatus may include or be coupled to other units or modules etc., such as radio parts or radio heads, used in or for transmission and/or reception. This is depicted in FIG. 8 as optional block 806.

Yet another example of an apparatus comprises means 804 (806) for transmitting an indication of device-to-device communications between a plurality of user devices to an access node, means 804 (806) for receiving an information on a configuration for device-to-device control information signaling via the access node, and means 804 (806) for transmitting the device-to-device control signalling according to the informed configuration via the access node.

It should be understood that the apparatus may include or be coupled to other units or modules etc., such as radio parts or radio heads, used in or for transmission and/or reception. This is depicted in FIG. 8 as optional block 806. The apparatus may also include at least one sensor, actuation system, radar or a like.

Although the apparatuses have been depicted as one entity in FIG. 8, different modules and memory may be implemented in one or more physical or logical entities.

An apparatus may in general include at least one processor, controller or a unit or module designed for carrying out functions of embodiments operationally coupled to at least one memory unit (or service) and to typically various interfaces. Further, the memory units may include volatile and/or non-volatile memory. The memory unit may store computer program code and/or operating systems, information, data, content or the like for the processor to perform operations according to embodiments described above in relation to FIGS. 2, 3, 4, 5 and/or 6. Each of the memory units may be a random access memory, hard drive, etc. The memory units may be at least partly removable and/or detachably operationally coupled to the apparatus. The memory may be of any type suitable for the current technical environment and it may be implemented using any suitable data storage technology, such as semiconductor-based technology, flash memory, magnetic and/or optical memory devices. The memory may be fixed or removable.

The apparatus may be an electronic circuit or a system of electronic circuits performing a particular function in an electronic device with a computer program code. The electronic circuit may comprise at least one processor and additionally at least one internal or external memory.

The apparatus may be, include or be associated with at least one software application, module, unit or entity configured as arithmetic operation, or as a program (including an added or updated software routine), executed by at least one operation processor. Programs, also called program products or computer programs, including software routines, applets and macros, may be stored in any apparatus-readable data storage medium and they include program instructions to perform particular tasks. The data storage medium may be a non-transitory medium. The computer program or computer program product may also be loaded to the apparatus. A computer program product may comprise one or more computer-executable components which, when the program is run, for example by one or more processors possibly also utilizing an internal or external memory, are configured to carry out any of the embodiments or combinations thereof described above by means of FIGS. 2, 3, 4, 5 and/or 6. The one or more computer-executable components may be at least one software code or portions thereof. Computer programs may be coded by a programming language or a low-level programming language.

Modifications and configurations required for implementing functionality of an embodiment may be performed as routines, which may be implemented as added or updated software routines, application circuits (ASIC) and/or programmable circuits. Further, software routines may be downloaded into an apparatus. The apparatus, such as a node device, or a corresponding component, may be configured as a computer or a microprocessor, such as single-chip computer element, or as a chipset, including at least a memory for providing storage capacity used for arithmetic operation and an operation processor for executing the arithmetic operation.

Embodiments provide computer programs embodied on a distribution medium, comprising program instructions which, when loaded into electronic apparatuses, constitute the apparatuses as explained above. The distribution medium may be a non-transitory medium.

The computer program may be in source code form, object code form, or in some intermediate form, and it may be stored in some sort of carrier, distribution medium, or computer readable medium, which may be any entity or device capable of carrying the program. Such carriers include a record medium, computer memory, read-only memory, photoelectrical and/or electrical carrier signal, telecommunications signal, and software distribution package, for example. Depending on the processing power needed, the computer program may be executed in a single electronic digital computer or it may be distributed amongst a number of computers. The computer readable medium or computer readable storage medium may be a non-transitory medium.

The techniques described herein may be implemented by various means. For example, these techniques may be implemented in hardware (one or more devices), firmware (one or more devices), software (one or more modules), or combinations thereof. For a hardware implementation, the apparatus may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, digitally enhanced circuits, other electronic units designed to perform the functions described herein, or a combination thereof. For firmware or software, the implementation may be carried out through modules of at least one chip set (e.g., procedures, functions, and so on) that perform the functions described herein. The software codes may be stored in a memory unit and executed by processors. The memory unit may be implemented within the processor or externally to the processor. In the latter case it may be communicatively coupled to the processor via various means, as is known in the art. Additionally, the components of systems described herein may be rearranged and/or complimented by additional components in order to facilitate achieving the various aspects, etc., described with regard thereto, and they are not limited to the precise configurations set forth in the given figures, as will be appreciated by one skilled in the art.

It will be obvious to a person skilled in the art that, as technology advances, the inventive concept may be implemented in various ways. The invention and its embodiments are not limited to the examples described above but may vary within the scope of the claims.

1. An apparatus comprising:
at least one processor and at least one memory including a computer program code, the at least one memory and the computer program code configured to, with the at least one processor, cause the apparatus at least to:
obtain an indication of device-to-device communication between a plurality of user devices;
obtain information on an operation mode of the plurality of user devices;
if the operation mode of the plurality of user devices is a half duplex mode: configure a cellular uplink control channel for a first user device of the plurality of user devices and a cellular downlink control channel for a second user device of the plurality of user devices for device-to-device control information as a pair of control channels;
if the operation mode of the plurality of user devices is a full duplex mode: configure a cellular shared control channel and/or reallocate an existing cellular uplink control channel and/or an existing cellular downlink control channel for device-to-device control information;
if the operation mode of at least one of the plurality of user devices is a half duplex mode and of at least one other of the plurality of user devices is a full duplex mode: configure for the at least one of the plurality of user devices in the half duplex mode a cellular uplink control channel and/or a cellular downlink control channel as a pair of control channels and configure a cellular shared control channel and/or reallocate an existing cellular uplink control channel and/or an existing cellular downlink control channel for the at least one other of the plurality of user devices in the full duplex mode, the cellular uplink control channel, the cellular downlink control channel and the cellular shared control channel being for device-to-device control information, and
inform the configuration or the reallocation to at least one of the plurality of user devices.

2. The apparatus of claim 1, further comprising causing the apparatus to:
identify the cellular uplink control channel and the cellular downlink control channel as paired by a pairing identity or by identifying the plurality of user devices.

3. The apparatus of claim 1, further comprising causing the apparatus to:
convey the device-to-device control information received on the cellular uplink control channel by using the cellular downlink control channel; and/or
convey the device-to-device control information received on the cellular shared control channel by using the cellular shared control channel.

4. The apparatus of claim 1, wherein the cellular uplink control channel is a physical uplink control channel, the cellular downlink control channel is a physical downlink control channel and the cellular shared control channel is a physical control channel.

5. The apparatus of claim 1, wherein the indication of the device-to-device communications is a request for control signaling resources.

6. The apparatus of claim 1, further comprising causing the apparatus to:
control the device-to-device control information by at least one of the following: forwarding, processing, at least partly retaining and appending additional information.

7. The apparatus of claim 1, further comprising a radio interface entity providing the apparatus with capability for radio communications.

8. An apparatus comprising:
at least one processor and at least one memory including a computer program code, the at least one memory and the computer program code configured to, with the at least one processor, cause the apparatus at least to:
transmit an indication of device-to-device communications between a plurality of user devices to an access node;
receive an information on a configuration for device-to-device control information signaling via the access node, and
transmit the device-to-device control signalling according to the informed configuration via the access node.

9. The apparatus of claim 8, wherein the indication comprises information on an operation mode of at least one of the plurality of user devices, the operation modes being a half-duplex mode and a full-duplex mode.

10. The apparatus of claim 8, wherein the configuration comprises at least one of the following: a cellular uplink control channel and a cellular shared control channel.

11. The apparatus of claim 10, wherein the cellular uplink control channel is a physical uplink control channel and the cellular shared control channel is a physical shared control channel.

12. The apparatus of claim 8, wherein the indication of the device-to-device communications is a request for control signaling resources.

13. The apparatus of claim 8, further comprising a radio interface entity providing the apparatus with capability for radio communications.

14. A method comprising:
obtaining an indication of device-to-device communication between a plurality of user devices;
obtaining information on an operation mode of the plurality of user devices;
if the operation mode of the plurality of user devices is a half duplex mode: configuring a cellular uplink control channel for a first user device of the plurality of user devices and a cellular downlink control channel for a second user device of the plurality of user devices for device-to-device control information as a pair of control channels;
if the operation mode of the plurality of user devices is a full duplex mode: configuring a cellular shared control channel and/or reallocating an existing cellular uplink control channel and/or an existing cellular downlink control channel for device-to-device control information;
if the operation mode of at least one of the plurality of user devices is a half duplex mode and of at least one other of the plurality of user devices is a full duplex mode: configuring for the at least one of the plurality of user devices in the half duplex mode a cellular uplink control channel and/or a cellular downlink control channel as a pair of control channels and configuring a cellular shared control channel and/or reallocating an existing cellular uplink control channel and/or an existing cellular downlink control channel for the at least one other of the plurality of user devices in the full duplex mode, the cellular uplink control channel, the cellular downlink control channel and the cellular shared control channel being for device-to-device control information, and
informing the configuration or the reallocation to at least one of the plurality of user devices.

15.-19. (canceled)

20. A method, comprising:
transmitting an indication of device-to-device communications between a plurality of user devices to an access node;
receiving an information on a configuration for device-to-device control information signaling via the access node, and
transmitting the device-to-device control signalling according to the informed configuration via the access node.

21.-28. (canceled)
